(19) United States
(12) Patent Application Publication
(10) Pub. No.: US 2018/0001290 A1
(43) Pub. Date: Jan. 4, 2018

(54) METHOD FOR THE WET DEPOSITION OF THIN FILMS

(71) Applicants: Prayon, Engis (BE); Université De Liège, Angleur (BE)

(72) Inventors: Carlos PAEZ, Liège (BE); Dimitri LIQUET, Angleur (BE); Cédric CALBERG, Esneux (BE); Benoît HEINRICHS, Liège (BE); Christelle ALIÉ, Liège (BE)

(73) Assignees: Prayon, Engis (BE); Université De Liège, Angleur (BE)

(21) Appl. No.: 15/537,711

(22) PCT Filed: Dec. 18, 2015
(86) PCT No.: PCT/EP2015/080694

§ 371 Date: Jun. 19, 2017

(30) Foreign Application Priority Data
Dec. 19, 2014 (BE) 2014/5132

(51) Int. Cl. B01J 13/00; H01M 4/04; C23C 24/08

(52) U.S. Cl. CPC B01J 13/0047; C23C 24/085; H01M 4/0452

(57) ABSTRACT

Methods for the deposition of thin films comprising at least preparing a solution containing at least one transition metal oxide powder in a solvent, continuously stirring said solution in order to form a sol, and using said sol in the form of said transition metal oxide film, wherein the powder is subjected to a preliminary preparation step.

### FIELD OF THE INVENTION

The invention relates to the depositions of films of oxide of transition metals by the wet route, for example by the sol-gel route. In particular, the invention relates to the deposition of films, preferably thin films, of lithiated oxide of transition metals.

The invention also relates to the use of said film prepared according to the present invention as electrode material in a battery, preferably a microbattery.

### STATE OF THE ART

The use of microbatteries, such as Li-ion batteries, comprising thin films of metal oxides, is experiencing a major expansion in numerous fields of application. These thin films are generally composed of lithiated oxide of transition metals, for example oxides of cobalt, manganese or nickel, or their mixture. These oxides are materials of choice in the preparation of an electrode material by virtue of their high specific insertion capacity and their excellent cyclability.

Thin films of metal oxides are mainly prepared by physical vapour deposition (PVD). This method consists in vaporizing the material at low pressure and in condensing it on the substrate. Two other techniques are regularly improved to form thin films of transition metals: pulsed laser deposition (PLD) and radio-frequency cathode sputtering (RF sputtering). Deposition by PLD is carried out with laser pulses fired at a target in order to make possible the evaporation of the material. Radiofrequency cathode sputtering consists in creating an argon plasma in a deposition chamber where the Ar⁺ ions mechanically bombard the target of the material in order to deposit it on the substrate. A stage of annealing, at very high temperature, of the material formed is necessary in order to promote the definitive formation of the material. This stage of annealing at very high temperature is incompatible with the incorporation of microbatteries on a flexible electronic circuit. The slowness of these processes limits the capabilities of industrial production. Furthermore, without heat treatment at high temperature, the capacity by weight of thin films of this type falls strongly after a few charge/discharge cycles. Chemical vapour deposition (CVD—vaporization of the precursors of transition metals at high temperature over the substrate) is an alternative to the preceding techniques but these processes require higher temperatures. In addition, the costs associated with the capital expenditure in order to make use of these technologies are very high.

In order to overcome the disadvantages of the vacuum deposition techniques, methods of preparation by the wet route have been explored. For example, the manufacture of thin films of composite materials by the sol-gel route is known from Patent WO2013171297. The manufacture consists, after functionalization of the substrate in a first alcoholic solvent, of the preparation of a sol composed of a functionalized powder and of a second alcoholic solvent and then the deposition of the sol on the substrate in order to form a first layer. The calcination of the sol at a temperature of between 50 and 500° C. makes possible the adhesion of the film thus formed. Lithiated cobalt oxide has in particular been immobilized: LiCoO₂ was prefunctionalized in a carboxylic acid solution before being dispersed in an ethanol solution in order to form a colloidal solution. The sol can be deposited on Alusi and on a support made of silicon covered with platinum.

It is also known to a person skilled in the art that the grinding of LCO powders brings about a deterioration in the electrochemical properties of these powders and that a heat treatment is necessary in order to enhance these properties, in particular the Journal of Electroanalytical Chemistry, 584 (2005), 147-156, of Alcantara and Ortiz.

Numerous documents also disclose techniques which make it possible to improve the cyclability performances of the materials, such as Cheng et al. in J. Phys. Chem. C, 2012, 116 (14), pp. 7629-7637, in particular by carrying out “atomic” deposition of alumina or titanium dioxide on LiCoO₂. The paper by Ting-Kuo Fey et al. in Surface and Coatings Technology, Volume 199, Issue 1, 2005, pages 22-31, discloses various technologies employed for the coating of titanium oxide. These authors do not characterize the layers but only the powders resulting from these treatments and use PVDF (poly(1,1-difluoroethylene)) as binder in order to render the particles coherent with one another and carbon for improving the electrical conductivity of the combination before carrying out the characterization thereof.

Papers also teach how to control the size of TiO₂ particles deposited, their structure, their texture and the stability of the solution; the paper by Paez et al., Applied Catalysis B: Environmental, 94 (2010), 263-271, “Unpredictable photocatalytic ability of H-2-reduced rutile-TiO₂ xerogel”, is known in particular.

The thin films prepared by the sol-gel route thus regularly exhibit problems of performance. Furthermore, the deposited layers adhere to the substrates by virtue of binders which unfortunately cannot be completely removed during the calcination and render the material unpure. The manufacture of thin films by the sol-gel route can thus be improved. In addition, the electrochemical properties of the materials deposited have to meet the requirements necessary in industrial applications of microbattery type.

### SUMMARY OF THE INVENTION

One of the aims of the present invention is to provide, starting from a metal oxide powder, a process for the deposition of improved “pure” films of oxide of transition metals exhibiting a good adhesion to a substrate and good electrochemical properties. The term “pure” is understood to mean, according to the present invention, the absence of carbon-based residues resulting from the process for processing the powder and the absence of binder and/or stabilizer. In addition, the invention also intends to provide for the stability of the solutions formed in order to meet the requirements of industrial use of this invention. Finally, the invention makes it possible to guarantee electrochemical performance of the layers prepared in concordance with the requirements of industrial applications of microbattery type, this being done while employing a process which is ecological and of low energy consumption by virtue of the use of appropriate solvents.

According to a first aspect, the invention provides a process for the deposition of films of oxide of transition metals, preferably by the liquid route. The said process comprises the stages of:
(a) providing a powder of oxide of transition metals of formula AₐM_{b}O_{c}, in which:
   A is an alkali metal; advantageously, A is chosen from the group consisting of Li, Na and K, or their mixture;
   M is a metal or a mixture of metals chosen from transition metals, lanthanides or actinides; preferably, M is a transition metal or a mixture of transition metals chosen from the elements of Groups 3 to 12 of the Periodic Table;
   advantageously, M is chosen from the group consisting of Co, Ni, Mn, Fe, Cu, Ti, Cr, V and Zn, and their mixtures;
   O is oxygen,
   a, b and c are real numbers greater than 0; a, b and c are chosen so as to provide electrical neutrality;
(b) preparing a colloidal sol from the said powder processed in stage (a),
(c) processing the said colloidal sol in the form of the said film of oxide of transition metals on a substrate, preferably degreased beforehand using a solution containing a first alcoholic or alkaline solvent S1, the said processing comprising:
   (c′) the deposition of one or more layers of the said sol on the said substrate and
   (c″) the annealing of the said one or more layers formed in stage (c′) in order to prepare the said film of oxide of transition metals,
      characterized in that the said colloidal sol is prepared by:
   (b′) providing the said powder AₐM_{b}O_{c} having a desired particle size distribution;
   (b″) calcining the said powder obtained after stage (b′),
   (b′″) mixing the said powder obtained after the calcining of stage (b′″) with one or more second solvent S2 in order to form the said colloidal sol;
      the said colloidal sol thus formed consists of one or more oxides of metals and a solvent.

Preferably, the process relates to the manufacture of thin films of oxide of transition metals. The term “thin” as used here relates to the mean thickness of the said film of oxide of transition metals, the said mean thickness being less than 250 μm. The film can be flat, raised, crenellated or stepped.

Preferably, the present process relates to the manufacture of films of oxide of transition metals, advantageously of lithiated oxide of transition metals, that is to say comprising lithium.

According to a second aspect, the invention provides a colloidal sol which can be obtained by a process as described above, the said colloidal sol consisting of:
one or more oxides of transition metals of formula AₐM_{b}O_{c} as are defined above,
a solvent S2 as defined above, and
optionally, a dopant Z selected from the oxides of transition metals of Groups 3A, 3B, 4 and/or 13 of the Periodic Table or a mixture of these oxides.
   The colloidal sol of the present invention preferably does not contain other carbon-based substances than S2 and optionally S3.

According to another aspect of the invention, a film of oxide of transition metals prepared according to the present invention can be used as electrode material, preferably as electrode material in a microbattery with an insertion capacity of greater than or equal to 60% of the theoretical reversible insertion capacity, advantageously greater than or equal to 70% and preferably greater than or equal to 80%.

### BRIEF DESCRIPTION OF THE FIGURES

FIG. 1 exhibits the particle size distribution curve of ground and unground LiCoO₂ according to a specific embodiment of the present invention.

FIG. 2 represents two X-ray diffraction (XRD) diagrams respectively of a powder and of a film of LiCoO₂ prepared according to a specific embodiment of the present invention.

FIG. 3 represents the cyclic voltammetry of a film of LiCoO₂ prepared according to a specific embodiment of the invention illustrating the change in the current as a function of the potential.

FIGS. 4 and 5 represent the charge and discharge capacities of a film of LiCoO₂ prepared according to two specific embodiments of the invention as a function of the number of charge and discharge cycles undergone by the electrode.

### DETAILED DESCRIPTION OF THE INVENTION

According to a first aspect, the invention provides a process for the deposition of films of oxide of transition metals, preferably by the liquid route. The said process comprises the stages of:
a) providing a powder of oxide of transition metals of formula AₐM_{b}O_{c},
b) preparing a colloidal sol from the said powder processed in stage a),
c) processing the said colloidal sol in the form of the said film of oxide of transition metals on a substrate which is clean and dry and thus preferably degreased beforehand using a solution containing a first alcoholic or alkaline solvent S1.

The said powder of oxide of transition metals is of formula AₐM_{b}O_{c}, in which:

A is an alkali metal; advantageously, A is chosen from the group consisting of Li, Na and K, or their mixture;
M is a metal or a mixture of metals chosen from transition metals, lanthanides or actinides; preferably, M is a transition metal or a mixture of transition metals chosen from the elements of Groups 3 to 12 of the Periodic Table; advantageously, M is chosen from the group consisting of Co, Ni, Mn, Fe, Cu, Ti, Cr, V and Zn, and their mixtures;
O is oxygen,
a, b and c are real numbers greater than 0; a, b and c are chosen so as to provide electrical neutrality.

The said colloidal sol is prepared by:

b′) providing the said AₐM_{b}O_{c} powder having a desired particle size distribution, preferably by grinding the said powder of oxide of transition metals AₐM_{b}O_{c},
b″) calcining the said powder obtained after stage b′),
b′″) mixing the said powder obtained after the calcining of stage b″) with one or more second solvent S2 in order to form the said colloidal sol.

The processing of the said colloidal sol in the form of the said film of oxide of transition metals on a substrate (stage c)) comprises:
c′) the deposition of one or more layers of the said sol on the said substrate and
c″) the annealing of the said one or more layers formed in stage c′) in order to prepare the said film of oxide of transition metals.

The said colloidal sol formed in stage b) to stage b′″) does not contain other carbon-based substances than precursors of oxides or the solvent, if it contains it, for example the solvent S2.

According to a preferred embodiment, the process additionally comprises a stage of doping by deposition of a dopant Z at the surface of the powder. Preferably, the deposition of the dopant Z is carried out in the form of a suspension or of a solution of the dopant Z in a solvent S3. The deposition of the dopant Z can advantageously be carried out either directly on the powder in stage (a) or, preferably, during stage (b) of formation of the sol. The dopant Z is preferably selected from the oxides of transition metals of Groups 3A, 3B, 4 and/or 13 of the Periodic Table, preferably chosen from the group consisting of Al₂O₃, La₂O₃, ZrO₂, TiO₂, SiO₂, Li₇La₃Zr₂O₁₂, LaZrO, Li₂ZrO₃ and La₂Zr₂O₇, or a mixture of these oxides, in order to form a powder of formula AₐM_{b}O_{c} as defined in Claim 1 doped with the dopant Z. In this embodiment, the said colloidal sol does not comprise other carbon-based substances than the solvents S2 and S3 or the precursors of the dopant.

The amount of dopant Z is added so that the proportion of dopant Z in the colloidal sol is from 0 to 5% by weight of the colloidal sol, advantageously between 0 and 3% by weight and preferably between 1 and 2% by weight.

A preferred route to introducing the doping agent Z is cogelling: a sol of an organometallic complex of an element belonging to the 3A, 3B, 4^{th} and/or 13^{th} Group of the Periodic Table is added to a suspension of the ground and calcined powder of oxide of transition metals of formula AₐM_{b}O_{c} in a solvent S3. The addition of water makes possible the functionalization of the surface of the oxide powder. The doped powder subsequently has to be dried and matured. Advantageously, the drying will be carried out at the temperature of evaporation of the solvent S3. The maturing stage consists of the maintenance of the doped solid at 150° C. and under 20 mbar for 24 h.

Advantageously, the organometallic complex employed is titanium tetraisopropoxide (TTiP) and the solvent S3 is chosen independently of the solvents S1 and S2. It can also be identical to S1 and/or S2.

The solvents S2 and S3 are selected, independently of one another, preferably from the group consisting of water and organic solvents exhibiting at least one alcohol functional group and having a saturated or unsaturated and linear or branched chain. The solvents used must be selected so that they do not react chemically with the powder for S2 and with the dopant Z or the powder for S3. Advantageously, the solvents S2 and S3 are selected, independently of one another, from the group consisting of water and alcohols having a boiling point of less than 150° C. at atmospheric pressure. Preferably, the solvents S2 and S3 are selected, independently of one another, from the group consisting of methanol, ethanol, propan-1-ol, isopropanol, butanol, pentanol and methoxyethanol. The solvent S1 is chosen from the group consisting of water, alkaline liquids and organic solvents exhibiting at least one alcohol functional group and having a saturated or unsaturated and linear or branched chain. Advantageously, the solvent S1 is selected from the group consisting of water, alkaline liquids and alcohols having a boiling point of less than 150° C. at atmospheric pressure. Preferably, the solvent S1 is selected from the group consisting of water, alkaline solutions, Gardoclean S5183, methanol, ethanol, propan-1-ol, isopropanol, butanol, pentanol and methoxyethanol.

When several layers of the said sol are formed on a substrate, the annealing stage carried out in stage c″) can be carried out after deposition of each of the layers of the said sol or after the deposition of several layers of the said sol.

The said annealing stage (stage c″) of the present process is carried out at a temperature of between 250° C. and 500° C., in particular between 300° C. and 450° C. and more particularly between 350° C. and 400° C. The annealing stage can be carried out each time that a layer of the said sol is deposited, i.e. each time that stage c′) is carried out, or after several successive depositions of layers. The said one or more layers are maintained at the annealing temperature for a period of time of between 30 seconds and 2 hours, preferably between 5 minutes and 1 hour. The annealing stage c″) makes possible the evaporation of the solvent and makes it possible to obtain the desired film of oxide of metals.

The powder of oxide of transition metals of formula AₐM_{b}O_{c} as defined above can be chosen from the group consisting of LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiNi_{0.5}Mn_{1.5-z}Ti_{z}O₄ where z is a number between 0 and 1.5, LiMn₂O₄, Li₄Mn₅O₁₂, LiNiO₂ and Li₄Ti₅O₁₂. Advantageously, the powder of oxide of transition metals of formula AₐM_{b}O_{c} as defined above can be LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}C_{1/3}O₂, LiNi_{0.8}Co_{0.2}O₂, LiMn₂O₄, Li₄Mn₅O₁₂, LiNiO₂ or Li₄Ti₅O₁₂, preferably LiCoO₂, LiMnO₂, LiMn₂O₄, Li₄Mn₅O₁₂, LiNiO₂ or Li₄Ti₅O₁₂.

Preferably, the deposition of one or more layers of the said sol on a substrate is carried out on a substrate having a temperature capable of making possible the evaporation of the said second solvent S2, advantageously a temperature close to the boiling point of the said second solvent S2. The term “close” as used here corresponds to a temperature range, the low limit of which is equal to 30° C. below the boiling point of the said polar organic solvent and the upper limit of which is equal to 10° C. above the boiling point of the said polar organic solvent. Thus, the second solvent present in the sol is at least partially evaporated before the deposition of another layer of the said sol.

Preferably, the said substrate is a metal substrate. In particular, the said substrate can be an electrically conducting substrate. The substrate can comprise carbon, platinum, gold, stainless steel, platinum on SiO₂, ITO (indium tin oxide), platinum on a silica wafer or metal alloys comprising at least two of the elements chosen from nickel, chromium and iron. The said metal alloys can also comprise other elements chosen from molybdenum, niobium, cobalt, manganese, copper, aluminium, titanium, silicon, carbon, sulphur, phosphorus or boron. By way of examples, the metal alloys can be Ni₆₁Cr₂₂Mo₉Fe₅, Ni₅₃Cr₁₉Fe₁₉Nb₅Mo₃, Ni₇₂Cr₁₆Fe₈, Ni₅₇Cr₂₂Co₁₂Mo₉, Ni_{32.5}Cr₂₁Fe or Ni₇₄Cr₁₅Fe₇Ti_{2.5}Al_{0.7}Nb_{0.95}; in addition these can contain traces or low contents of one of the following compounds: molybdenum, niobium, cobalt, manganese, copper, aluminium, titanium, silicon, carbon, sulphur, phosphorus or boron. For example, the said metal alloys can be alloys of Inconel® type.

The deposition of the said sol on the substrate (stage c′)) can be carried out by spin coating or dip coating or spray coating or slide coating or screen printing or inkjet printing or roll coating.

According to a preferred embodiment, stages b′) and b′″) are carried out under ambient temperature and ambient pressure conditions. Stage c) can also be carried out under an ambient atmosphere, that is to say under an atmosphere neither controlled nor modified with respect to the ambient air.

The surface of the said film prepared according to the present invention can have a low roughness, advantageously of less than 2000 nm, preferably of less than 1000 nm and in particular of less than 500 nm. Preferably, the said film of oxide of transition metals can be deposited on a substrate. Thus, when the said film of oxide of transition metals can be deposited on a substrate, the roughness of the surface of the said film includes the roughness resulting from the surface of the said substrate. When the said film of oxide of transition metals is deposited on a substrate, the surface of the said film prepared according to the present invention can have a low roughness, advantageously of less than 2500 nm, preferably of less than 1200 nm and in particular of less than 520 nm. In particular, the process according to the invention makes it possible to provide for the formation of the said film of oxide of transition metals and its adhesion to substrates of low roughness, in particular substrates having a surface exhibiting a roughness Ra of less than 500 nm.

The film of oxide of transition metals according to the present invention can have a monolayer or multilayer structure according to the number of layers deposited in stage c′). The film of oxide of transition metals having a multilayer structure can be prepared by repeating stage c′) of the present process. Each stage c′) can be followed by the implementation of the stage c″) of annealing the layer formed at a temperature of between 150° C. and 500° C. Each layer of the multilayer structure can be independent of one another. Thus, each layer can have the same constitution, that is to say be composed of the same oxide or oxides of transition metals of formula AₐM_{b}O_{c} as described in the present invention. For example, a multilayer film of transition metals, such as LiCoO₂, might be formed by successive depositions on the substrate, that is to say by repeating stage c) one or more times until the desired multilayer structure is obtained.

The said sol prepared in stage b) can also contain electrically conducting particles, such as silver, gold, indium and platinum particles, carbon fibres, carbon nanoparticles or carbon nanotubes.

Alternatively, a film of multilayer structure can be formed by successive depositions of one or more layers of sols which are different and prepared from a powder of identical or different oxide of metals. Each sol can be prepared independently from a solution comprising a ground and calcined powder and a different second solvent. The said multilayer film can be prepared by repeating stages a) to c′) until the desired multilayer structure is obtained. For example, a first layer might comprise LiCoO₂; additional layers, deposited on the substrate prior or subsequent to this first layer, might without distinction comprise, for example, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiNi_{0.5}Mn_{1.5-z}Ti_{z}O₄ where z is a number between 0 and 1.5, LiMn₂O₄, LiMnO₂, Li₄Mn₅O₁₂, LiNiO₂, Li₄Mn₅O₂ or Li₄Ti₅O₁₂.

The film of oxide of transition metals having a multilayer structure can comprise between 2 and 200 layers, preferably between 2 and 100 layers. Each layer can have a thickness of between 0.01 and 2.5 μm independently of one another.

The film of oxide of transition metals according to the present invention can have a mean thickness of between 0.01 μm and 250 μm, preferably between 0.1 and 50 μm, preferably between 1 and 30 μm, preferably between 0.5 and 10 μm.

The process according to the invention makes it possible to deposit a film of oxide of transition metals such that the capacity by weight of the material is at least 60% of the theoretical reversible specific capacity of the latter, advantageously greater than 70% and in particular greater than 80%. In the specific case of an LiCoO₂ film, the capacity by weight measured is greater than 90 mA·h/g, advantageously greater than 100 mA·h/g; the theoretical capacity by weight is determined in the first discharge cycle. Preferably, the capacity by weight of the said film of oxide of transition metals after more than 20 discharge cycles is at least greater than 70% of the theoretical capacity by weight measured under C/10 conditions. The theoretical reversible specific capacity is commonly accepted as being half of the theoretical amount of ions which can be inserted into or extracted from one gram of electrode material. In the case of LiCoO₂, the theoretical reversible specific capacity is 137 mA·h/g.

Surprisingly, it has been observed that the particle size selection of the particles of oxide of transition metals, followed by a calcination of the powder thus obtained, does not result in the coalescence of the particles and makes it possible to prepare a sol which is stable in a solvent without a chelating agent, this sol exhibiting the distinguishing feature of adhering to a substrate without a binding agent. Thus, the colloidal sol does not contain other carbon-based substances than the solvent, even if it contains it, and the dopant precursors. The colloidal sol is regarded as stable if it has been possible to store it for 24 hours without any precipitation having been observed. In addition, the solvent is chosen from water and the group of the organic solvents exhibiting at least one alcohol functional group which have a low boiling point at atmospheric pressure, i.e. of less than 150° C. and preferably of less than 110° C. Advantageously, the second solvent can be chosen from methanol, ethanol, methoxyethanol, propan-1-ol, isopropanol, butanol, pentanol and water.

The proportion of powder in the colloidal sol is between 2 and 100 g per litre of colloidal sol, preferably between 2 and 50 g/l of colloidal sol. Alternatively, the proportion of powder in the colloidal sol is greater than 100 g per litre of colloidal sol.

The grinding of the powder is carried out in a solid-phase mill. The grinding is carried out so (adjustment: grinding time/speed) that the particles after grinding exhibit a d50 of between 0.1 and 10 μm, preferably of between 0.1 and 5 μm and preferentially between 0.5 and 1.5 μm. In the case where the AₐM_{b}O_{c} powder was available in the desired particle size distribution, it is clear that the grinding stage can be omitted.

The duration and the temperature of the calcination are adjusted with the aim of obtaining the electrochemical properties necessary for the applications envisaged. The calcination of the powder is carried out at a temperature of between 350° C. and 800° C. according to the oxide of transition metals employed, preferably between 500 and 750° C. The duration of calcination is from 1 to 15 hours, preferably from 2 to 10 hours and more preferably from 3 to 5 hours.

The powder of oxide of transition metals of formula AₐM_{b}O_{c} as defined above can be chosen from the group consisting of LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiNi_{0.5}Mn_{1.5-z}Ti_{z}O₄ where z is a number between 0 and 1.5, LiMn₂O₄, Li₄Mn₅O₁₂, LiNiO₂ and Li₄Ti₅O₁₂. Advantageously, the powder of oxide of transition metals of formula AₐM_{b}O_{c} as defined above can be LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiMn₂O₄, Li₄Mn₅O₁₂, LiNiO₂ or Li₄Ti₅O₁₂, preferably LiCoO₂, LiMnO₂, LiMn₂O₄, Li₄Mn₅O₁₂, LiNiO₂ or Li₄Ti₅O₁₂.

As mentioned above, the film of oxide of transition metals as described in the present invention can be used as electrode material, preferably as material of a positive electrode. The said electrode can thus be used in a microbattery. Preferably, the film of oxide of transition metals according to the present invention used as electrode materials is obtained by stages a) to c) or a) to c″) of the process according to the present invention. The film of oxide of transition metals as described in the present invention can be used in a fuel cell. The film of oxide of transition metals according to the present invention can be used as protective material for electrode material, preferably in fuel cells. Thus, the said film of oxide of transition metals can be deposited over all or a portion of the surface of an anode or of a cathode.

According to a second aspect of the invention, a colloidal sol which can be obtained by a process as discussed above is provided. The said sol consists of:
one or more oxides of transition metals of formula AₐM_{b}O_{c} which are or are not doped, as defined above,
a solvent S2 as defined above and preferably chosen from water and organic solvents exhibiting an alcohol functional group which have a low boiling point at atmospheric pressure, i.e. of less than 150° C., preferably of less than 110° C. Advantageously, the second solvent S2 can be chosen from methanol, ethanol, methoxyethanol, propan-1-ol, isopropanol, butanol, pentanol and water, and
optionally, a dopant Z selected from oxides of transition metals of Groups 3A, 3B, 4 and/or 13 of the Periodic Table or a mixture of these oxides, with or without a solvent S3 as discussed above. The solvent S3 can be absent in the case where it would not have been used for the deposition of the dopant, in the case where it would have been used but would have evaporated or when S3 is the same solvent as S2 and thus cannot be distinguished from the latter.

The powder of oxide of transition metals of formula AₐM_{b}O_{c} as defined above can be chosen from the group consisting of LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn₁₃Co_{1/3}O₂, LiNi_{0.8}Co_{0.2}O₂, LiNi_{0.5}Mn_{1.5-z}Ti_{z}O₄ where z is a number between 0 and 1.5, LiMn₂O₄, Li₄Mn₅O₁₂, LiNiO₂ and Li₄Ti₅O₁₂. Advantageously, the powder of oxide of transition metals of formula AₐM_{b}O_{c} as defined above can be LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn₁₃Co_{1/3}O₂, LiNi_{0.8}Co_{0.2}O₂, LiMn₂O₄, Li₄Mn₅O₁₂, LiNiO₂ or Li₄Ti₅O₁₂, preferably LiCoO₂, LiMnO₂, LiMn₂O₄, Li₄Mn₅O₁₂, LiNiO₂ or Li₄Ti₅O₁₂.

The sol is stable; it makes it possible to be stored at ambient temperature for at least 24 hours.

The sol advantageously exhibits a concentration of oxide of transition metals of between 1 and 100 g per litre of sol, preferably of between 2 and 50 g per litre of sol, preferably between 3 and 10 g per litre of sol.

Alternatively, the sol advantageously exhibits a concentration of oxide of transition metals of greater than 100 g per litre of sol.

The sol can contain one or more oxides of transition metals and one or more dopants Z of the type of oxide of elements belonging to Groups 3A, 3B, 4 and/or 13 of the Periodic Table and the solvent S2 and the solvent S3.

### EXAMPLES

### General Protocol for the Determination of the Characteristics of the Films Deposited According to the Present Invention

Procedure for Determining the Roughness

The roughness Ra of the surfaces corresponds to the arithmetic mean of the absolute values of the differences between the profile and a mean line of this profile; it is expressed in microns. It was measured using a contact profilometer having the Dektak tradename (supplier Bruker), the stylus of which exhibits a radius of curvature of 12.5 microns.

Procedure for Determining the Adhesion

The adhesion is measured after the processing of the said sol in the form of the said film of oxide of transition metals. Thus, the adhesion can be measured after the processing of stage c′) of deposition of one or more layers, preferably after the said heat treatment, and after the processing of stage c″) of annealing the said film of oxide of transition metals. The adhesion is measured first of all by simple inclination of the substrate once covered with one or more layers of the said sol (stage c′)). The said one or more layers deposited are regarded as adhering to the substrate if they do not deteriorate under the effect of the inclination. A rubbing test is then carried out and consists in passing the finger or a dry cloth over the substrate covered with the said film of oxide of transition metals, i.e. after annealing (stage c″)). A visual inspection of the coated substrate makes it possible to evaluate the measurement of the adhesion of the coating, a coating being defined as adhering to the substrate when at least one layer of the said film of oxide of transition metals remains on the substrate.

Procedure for determining the electrochemical performances of the materials

The electrochemical performances of the materials are evaluated by measurements of cycling in galvanostatic mode with limitation in potential. The capacity by weight of the material is evaluated by integrating the current passing through the material during each charge (or discharge) cycle with respect to the weight deposited.

Procedure for determining the purity of the materials

The purity of the materials can be evaluated by X-ray diffraction (XRD) and by cyclic voltammetry, where the current is measured as a function of increments in potential.

### General Protocol for the Preparation of a Substrate and the Preparation of a Ground and Calcined Oxide of Transition Metals According to the Present Invention

Process for the Preparation of the Powders: Grinding and Calcination

The commercial lithium cobalt oxide (LiCoO₂) was purchased from Sigma-Aldrich (CAS No.: 12190-3). 6.0 g of LiCoO₂ were ground in a planetary ball mill (Planetary Mono Mill PULVERISETTE 6 classic line) at 650 revolutions per minute (rpm) for 60 cycles. Characteristics of the mill: 20 beads with a diameter of 15 mm are used (agate, SiO₂) in an 80 ml agate bowl. During each cycle, the mill rotates for 5 minutes and pauses for 10 minutes. Name of the sample: LiCo-65.

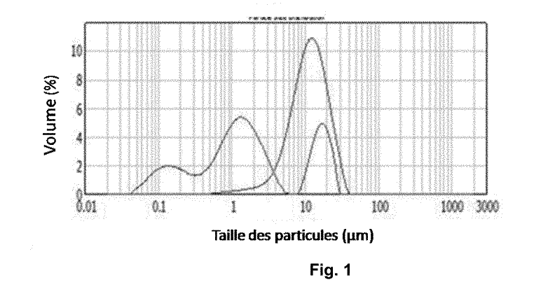

The change in particle size distribution subsequent to the grinding of the sample LiCo-65 is shown in FIG. 1: a strong decrease in the volume percentage (from 11% to 5%) of particles having a size of between 10 and 11 μm can be observed; this effect is accompanied by an increase in the volume percentage (from 0.5% to 5.0%) of particles in the vicinity of 1.0 μm. The appearance of LiCoO₂ nanoparticles in the vicinity of 100 nm with a volume percentage of 2% can also be observed.

The ground LiCoO₂ (LiCo-65) was subsequently calcined at 700° C. for 2.5 h (20° C./min). Name of the sample: LiCo-65/700.

Preparation of the Substrate

A degreasing solution was prepared by mixing 15 g of the product S5183 (Gardoclean from Chemetal) in 1 l of deionized water. 8 stainless steel discs were slowly submerged in this degreasing solution for a few seconds and finally slowly removed from the solution. These two stages were repeated 10 times for each disc. Subsequently, the discs were washed with deionized water. The discs were subsequently dried at 120° C. for 1 h.

General procedure for the deposition of the thin layers

LiCoO₂ was immobilized on stainless steel discs (diameter=15.5 mm). Before being used, the discs were degreased, washed and dried. The deposition of LiCoO₂ as thin layers was carried out by spray coating. The 8 pretreated stainless steel discs are placed on the support at the centre of the spray coating device, which was preheated to 105° C.

### Example 1: Preparation of an LiCoO₂ Film According to the Invention

0.5 g of ground and calcined LiCoO₂ (LiCo-65/700) was suspended and dispersed in 100 ml of deionized water using ultrasound. After an ultrasonication time of 16 hours, the formation of a colloidal phase is observed. The colloid was separated from the excess solid after separation by settling for 4 h. Name of the colloid: LiCo-65/700 colloid.

The colloidal sol obtained was deposited by spray coating according to the protocol specified above. 50 ml of the colloid (LiCo-65/700 colloid) could be deposited on the substrate preheated to 105° C. Name of the samples: LiCo-65/700 Stainless steel. The LiCo-65/700 Stainless steel samples were subsequently annealed at 350° C. for 1 h (20° C./min). An amount of 1.10 mg of LiCo-65/700 could be deposited on each of the 8 stainless steel discs. Name of the samples: LiCo-65/700 Stainless steel/35.

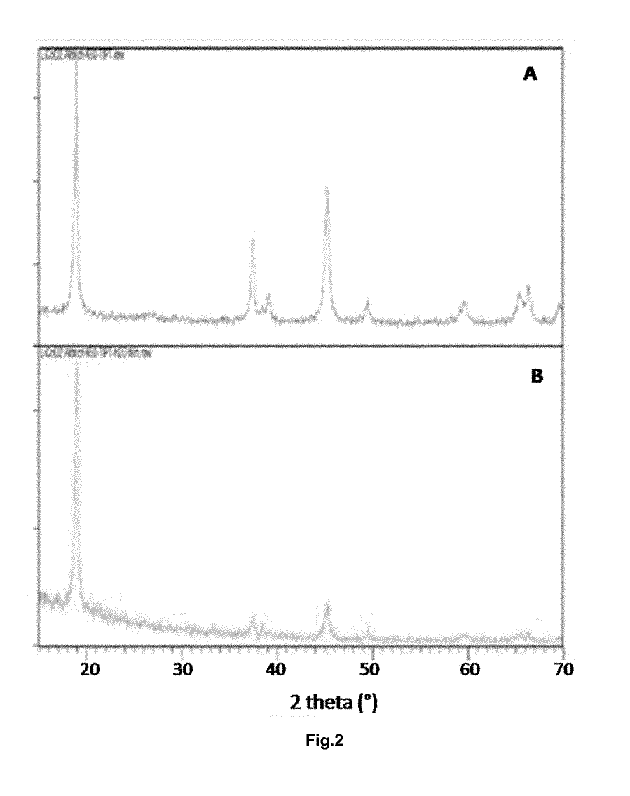

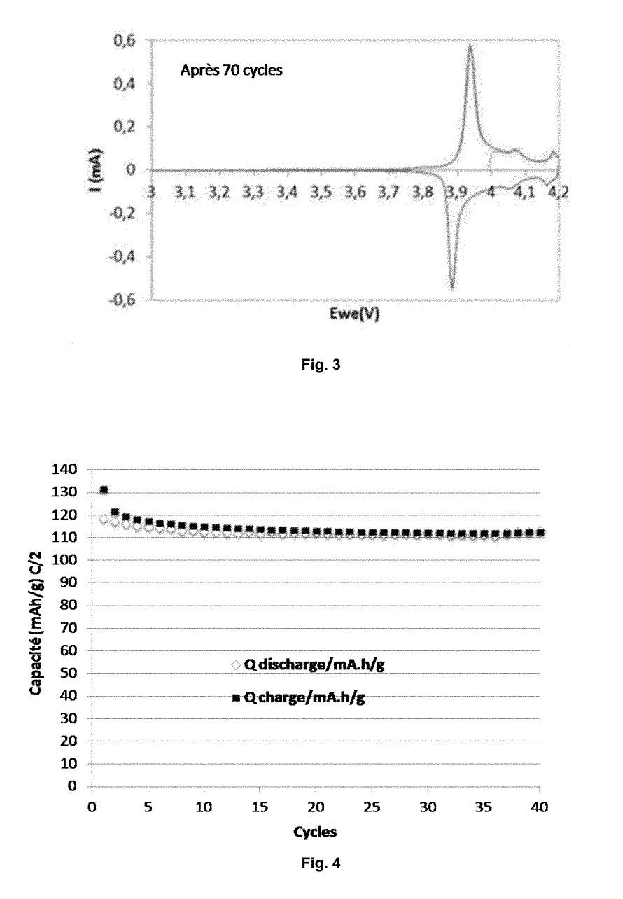

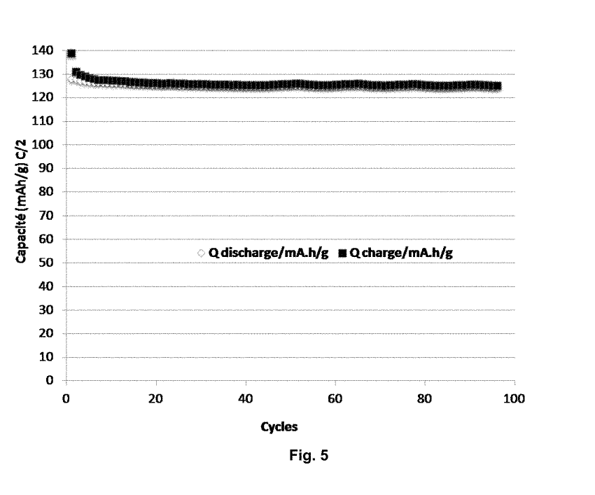

The XRD profiles of the samples of LiCoO₂ (FIG. 2, A) in the powder form and in the thin layer form (LiCo-65/700 Stainless steel/35; FIG. 2, B) are compared in FIG. 2. Great similarities between the diffraction profiles could be observed. The same peaks characteristic of high temperature LiCoO₂ in the vicinity of 19, 37.5, 38.5, 45, 49.5, 59.5, 65.5 and 66.5 (20) were obtained. The percentage of high temperature LiCoO₂ was determined from cyclic voltammetry (CV) and is given in FIG. 3. The electrochemical stability and the good cyclability of the material are demonstrated by FIG. 4, in which the charge and discharge capacity by weight of the same material under C/2 conditions for 30 cycles is observed, with an initial capacity by weight of the order of 120 mA·h/g (88% of the theoretical insertion capacity) and a loss of the initial discharge capacity of only 4% at the end of ten cycles.

### Example 2 (Invention): Deposition of LiCoO₂ Doped with TiO₂

A solution of “dopant” was prepared by mixing 7.7 ml of titanium isopropoxide (TTiP, Sigma-Aldrich, CAS No.: 546-68-9) in 41.7 ml of pure 2-methoxyethanol. A dilution solution was prepared by mixing 1.03 ml of deionized water in 41.25 ml of pure 2-methoxyethanol. 3.32 g of the LiCo-65/700 sample were suspended and dispersed in 400 ml of 2-methoxyethanol by stirring at 50° C. (1 hour). 0.66 ml of the “dopant” solution were added to this suspension (suspension Sp1). After stirring for 1 h (at 50° C.), 0.66 ml of the dilution solution were added to the suspension Sp1 (suspension Sp2). After stirring for 24 h (at 50° C.), the suspension Sp2 was evaporated on a rotary evaporator at 40° C. (30 mbar). The resulting solid was dried at 150° C. (20 mbar) for 24 h. Name of the sample: LiCo-65/700/TiO₂. 0.5 g of LiCo-65/700/TiO₂ were suspended and dispersed in 100 ml of deionized water and mixed under ultrasound. After 16 h, the formation of a colloidal phase is observed. The colloidal sol was separated from excess solid after separating by settling for 4 h. Name of the colloid: LiCo-65/700/TiO₂ colloid.

The 8 pretreated stainless steel discs are placed on the support at the centre of the spray coating device, which is preheated to 105° C. 50 ml of the colloid (LiCo-65/700/TiO₂ colloid) could be deposited on the substrate preheated to 105° C. Name of the samples: LiCo-65/700/TiO₂ Stainless steel.

The 8 LiCo-65/700/TiO₂ Stainless steel samples were annealed at 350° C. for 1 h (20° C./min) and an amount of 1.10 mg of LiCo-65/700/TiO₂ could be deposited on each of the discs. Name of the samples: LiCo-65/700/TiO₂ Stainless steel/35.

The charge and discharge capacity by weight is presented in FIG. 5. With an initial capacity by weight of 128.12 mA·h/g and a loss in the initial discharge capacity of 1.4% after ten cycles, the system stabilizes and the loss is only 1.83% of the initial discharge capacity after 100 cycles. After 100 cycles, the theoretical insertion capacity is still more than 85%.

TABLE 1
Data relating to the formation of a film of oxide of transition metals
and its adhesion to a substrate

| | | | | Heating | | |
|---|---|---|---|---|---|---|
| | LiCoO₂ | Weight | Rough- | temp. | | |
| | colloid | deposited | ness | (stage b″)) | % HT | |
| Sample | (g/l) | (mg) | (nm) | (° C.) | LiCoO₂ | Adhesion |
| Example 1 | 2.20 | 1.1 | 2600 | 350 | 95.2 | Yes |
| Example 2 | 2.40 | 2.22 | 2600 | 350 | 99.3 | Yes |

The main characteristics of the films obtained after application of the process according to the invention are summarized in Table 1.

1. A process for manufacturing a film of oxide of transition metals, the process comprising:
(a) providing a powder of formula AₐM_{b}O_{c}, in which:
A is an alkali metal;
M is a metal or a mixture of metals chosen from transition metals, lanthanides or actinides;
O is oxygen; and
a, b and c are real numbers greater than 0 and are chosen so as to provide electrical neutrality;
(b) preparing a colloidal sol from the said powder processed in (a),
(c) processing the said colloidal sol in the form of the said film of oxide of transition metals on a substrate degreased beforehand using a solution containing a first alcoholic or alkaline solvent S1, the said processing comprising:
(c′) depositing one or more layers of the said colloidal sol on the said substrate, and
(c″) annealing said one or more layers formed in stage (c′) in order to prepare the said film of oxide of transition metals,
wherein the said colloidal sol is prepared by:
(b′) providing the said powder AₐM_{b}O_{c} having a desired particle size distribution;
(b″) calcining the said AₐM_{b}O_{c} powder from (b′), and
(b′″) mixing the said powder obtained after the calcining of (b″)
with a second solvent S2 to form the said colloidal sol, and the said colloidal sol thus formed consists of one or more calcined oxides of metals and one or more solvents.

2. The process according to claim 1, wherein (b′) for providing the powder of desired particle size distribution comprises the grinding of the said powder of oxide AₐM_{b}O_{c}.

3. The process according to claim 1, further comprising doping by deposition of a dopant Z at the surface of the powder to form a powder of formula AₐM_{b}O_{c} as defined in (a) doped with the dopant Z.

4. The process according to claim 3, wherein the proportion of the dopant Z in the colloidal sol is from 0 to 5% by weight of the colloidal sol.

5. The process according to claim 1, wherein S2 is selected from the group consisting of:
water and
one or more organic solvents exhibiting at least one alcohol functional group and having a saturated or unsaturated and linear or branched chain.

6. The process according to claim 1, wherein particles of the powder before the calcination (b″) exhibit a d50 of between 0.1 and 10 μm.

7. The process according to claim 1, wherein said annealing (c″) is carried out at a temperature of between 250° C. and 500° C. and for a period of time of between 30 seconds and 2 hours.

8. The process according to claim 1, wherein the powder of oxide of transition metals of formula AₐM_{b}O_{c} is selected from the group consisting of LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiNi_{0.5}Mn_{1.5-z}Ti_{z}O₄ where z is a number between 0 and 1.5, LiMn₂O₄, Li₄Mn₅O₁₂, LiNiO₂ and Li₄Ti₅O₁₂.

9. The process according to claim 1, wherein the substrate used in (c′) is brought to a temperature of between 30° C. below the boiling point of the solvent S2 and 10° C. above the boiling point of the solvent S2.

10. The process according to claim 1, wherein (b″) is carried out at a temperature of between 350° C. and 800° C. for a calcination time of between 1 and 15 hours.

11. A colloidal sol obtained by the process according to claim 1, wherein said colloidal sol consists of:
one or more oxides of transition metals of formula AₐM_{b}O_{c} as defined in (a) of claim 1,
a solvent S2 selected from the group consisting of water and organic solvents exhibiting at least one alcohol functional group and having a saturated or unsaturated and linear or branched chain, and
optionally a dopant Z selected from oxides of transition metals of Groups 3A, 3B, 4 and/or 13 of the Periodic Table or a mixture of these oxides, with or without a solvent S3.

12. The colloidal sol according to claim 11, wherein the solvent S2 is selected from water and organic solvents having a boiling point of less than 150° C. at atmospheric pressure.

13. The colloidal sol according to claim 11, wherein the oxide of transition metals of formula AₐM_{b}O_{c} is selected from the group consisting of LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiNi_{0.5}Mn_{1.5-z}Ti_{z}O₄ where z is a number between 0 and 1.5, LiMn₂O₄, Li₄Mn₅O₁₂, LiNiO₂ and Li₄Ti₅O₁₂.

14. The colloidal sol according to claim 13, further comprising a dopant Z and a solvent S3, wherein Z is selected from the group of oxides of transition metals of Groups 3A, 3B, 4 and/or 13 of the Periodic Table and the solvent S3 is selected from the group consisting of:
water and
one or more organic solvents exhibiting at least one alcohol functional group and having a saturated or unsaturated and linear or branched chain.

15. The colloidal sol according to claim 11, wherein the proportion of the dopant Z in the colloidal sol is from 0 to 5% by weight of the colloidal sol.

16. The process according to claim 1, wherein A is selected from the group consisting of Li, Na, K and their mixture and M is selected from the group consisting of Co, Ni, Mn, Fe, Cu, Ti, Cr, V, Zn and their mixtures.

17. The process according to claim 3, wherein the dopant Z is selected from the group of oxides consisting of Al₂O₃, La₂O₃, ZrO₂, TiO₂, SiO₂, Li₇La₃Zr₂O₁₂, LaZrO, Li₂ZrO₃, La₂Zr₂O₇ and a mixture of one or more of these oxides.

18. The process according to claim 5, wherein the one or more organic solvents are selected from the group consisting of methanol, ethanol, propan-1-ol, isopropanol, butanol, pentanol and methoxyethanol.

19. The process according to claim 8, wherein the powder of oxide of transition metals being of formula AₐM_{b}O_{c} is selected from the group consisting of LiCoO₂, LiMnO₂, LiMn₂O₄, Li₄Mn₅O₁₂, LiNiO₂ and Li₄Ti₅O₁₂.

20. The colloidal sol according to claim 14, wherein:
the oxide of transition metals of formula AₐM_{b}O_{c} is selected from the group consisting of LiCoO₂, LiMnO₂, LiMn₂O₄, Li₄Mn₅O₁₂, LiNiO₂ and Li₄Ti₅O₁₂,
the dopant Z is selected from the group of oxides consisting of Al₂O₃, La₂O₃, ZrO₂, TiO₂, SiO₂, Li₇La₃Zr₂O₁₂, LaZrO, Li₂ZrO₃, La₂Zr₂O₇ and a mixture of one or more of these oxides; and
the one or more organic solvents are selected from the group consisting of methanol, ethanol, propan-1-ol, isopropanol, butanol, pentanol and methoxyethanol.
